(19) United States
(12) Patent Application Publication
(10) Pub. No.: US 2016/0121335 A1
(43) Pub. Date: May 5, 2016

(54) GRINDING ROLLER

(71) Applicant: LOESCHE GMBH, Düsseldorf (DE)

(72) Inventors: Joerg Bettenworth, Duesseldorf (DE); Thomas Letsch, Duesseldorf (DE); Michael Keyssner, Duesseldorf (DE)

(73) Assignee: LOESCHE GmbH, Duesseldorf (DE)

(21) Appl. No.: 14/896,162

(22) PCT Filed: Oct. 31, 2014
(86) PCT No.: PCT/EP2014/073477

§ 371 Date: Dec. 4, 2015

(51) Int. Cl. B02C 15/00; B02C 15/04

(52) U.S. Cl. CPC B02C 15/004; B02C 15/04

(57) ABSTRACT

The invention relates to a grinding roller having an inclined, fixed inner roller axle (3), a roller jacket (6) being provided on a roller base body (7). The rotatable roller base body (7) is mounted relatively to the fixed inner roller axle (3) by means of an arranged fixed bearing (11) and a floating bearing (12) which is spaced apart therefrom. The floating bearing (12) is provided in the region of the end face of the roller axle (3) and for supporting the roller base body (7) having the roller jacket (6) so as to allow their rotation, and the fixed bearing (11) is arranged on the roller axle (3) in an outwardly offset manner in the direction of the swing lever (14).

The invention relates to a grinding roller with an inclined, stationary inner roller shaft, wherein a roller jacket is provided on a roller base body and a double-row roller bearing is arranged as a locating bearing for mounting the rotatable roller base body relative to the stationary inner roller shaft and a cylindrical roller bearing spaced apart from the double-row roller bearing acts as a floating bearing.

Grinding rollers of this type are used above all in air-swept vertical mills for grinding cement raw material, cement, slag, ores or coal. Examples of such grinding rollers are known from DE 31 00 341 A1, WO 2005/028112 A1 or US 2005/0023390 A1.

Precisely in US 2005/0023390 A1, a bearing arrangement for the grinding roller and its base body or roller core and the roller jacket placed around the periphery thereof is also shown.

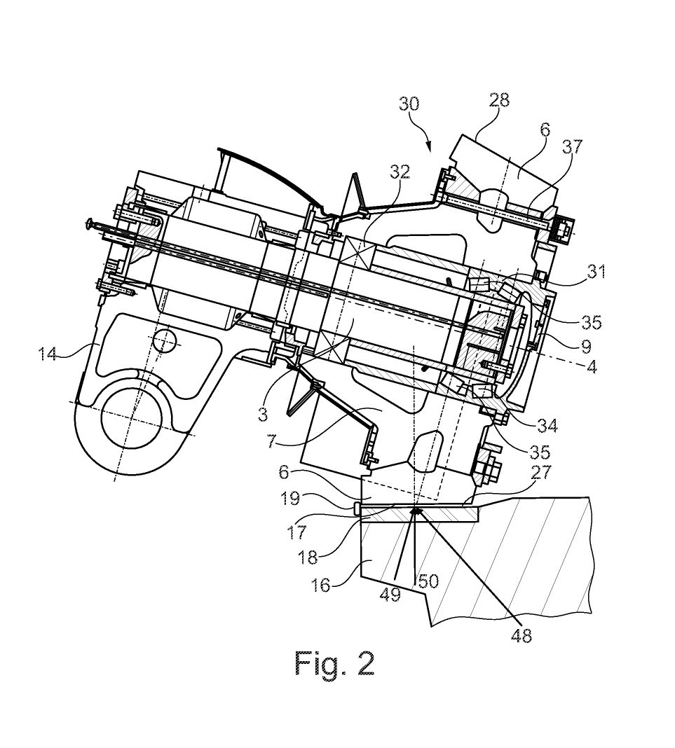

A bearing arrangement to date of a corresponding grinding roller is shown in a simplified manner in FIG. 2.

The inclined, stationary inner roller shaft 3 is fixed in an interlocking and/or a non-positive locking manner and rotationally securely in an opening region of a rocker arm 14, the opening region standing away from the roller shaft 3 approximately at a right angle.

To illustrate the forces acting on the roller jacket 6 and the grinding roller 30, an outer region of a grinding table 16 with grinding track 17 and grinding track plates 18 forming this are shown in a fragmented illustration.

The base body 7 of the grinding roller 30 carries on its peripheral region the roller jacket 6 formed in principle in a frusto-conical shape. The fastening between these parts is realised by means of clamping bolts 37. The base body 7 of the grinding roller 30 is mounted in the region of the end face 9 with respect to the roller shaft 3 by means of a double-row tapered roller bearing 31 with two rows 34, 35 of tapered rollers.

This bearing can be described as an inner locating bearing, wherein the term “inner” is to be understood to be a bearing orientated towards the middle or the inside of the mill or the grinding table 16.

Outwardly, spaced apart from this locating bearing 31, the base body 7 is mounted and supported with the roller jacket 6 through an outer-lying floating bearing 32, for example as a cylindrical roller bearing, with respect to the roller shaft 3.

The comminution or grinding process which takes place in the grinding gap 27 between the peripheral area of the roller jacket 6 and the raw material present on the grinding track 17 during operation is sufficiently known to the person skilled in the art in this field.

Due to the inwardly inclined shaft 4 of the grinding roller 30 and the inclination 28 of the roller jacket 6, at the grinding gap 27 the peripheral area of the roller jacket 6 and the grinding track plates 18 lie at a short distance approximately parallel to each other.

The grinding force required to comminute the raw material such as cement raw material or coal results, so to speak, from the weight force of the grinding roller 30 and the hydraulic additional force which is applied via a suspension system to the rocker arm 14 and thus to the roller jacket 6.

In the simplified illustration in FIG. 2, the forces acting through the grinding process on the grinding roller 30, for example in the middle of the roller jacket 6, are shown with arrows.

Due to the shaft 4 of the grinding roller 30 being inclined by approximately 15° the radial forces act approximately in the direction of the arrow 49 and the axial forces in the direction of the arrow 48, so that the resulting forces act in a simplified manner in the direction of the arrow 50 on the grinding roller 30 and the bearing arrangement thereof.

The bearing arrangement shown in FIG. 2 of grinding rollers 30 with an inner locating bearing and an outer-lying floating bearing has proved to be the best in practice over many years.

Due to the trend to achieve increasingly high throughputs of ground and classified fine material with vertical mills and the grinding rollers used therein, increasingly large grinding rollers have also been used. During operation there have been increasingly frequent problems and a high level of wear with the bearing arrangement used to date with an inner locating bearing and an outer-lying floating bearing.

Corresponding to the invention it has been recognised that the schematically plotted acting forces exert a different load on the two rows of the locating bearing 31 with the tapered rollers 34, 35. This is because only the inner, that is to say the row of tapered rollers 34 pointing towards the centre of the mill, absorbs the outwardly acting axial forces and, due to the inclination of the shaft 4, also the majority of the radial forces.

The outwardly orientated row of tapered rollers 35 is only loaded with low radial forces during normal operation. This extremely different radial load distribution shifts increasingly if the resulting grinding force 50 does not engage centrally on the roller jacket 6 but instead more in the direction of the larger grinding roller diameter, thus in the direction of the outer edge of the grinding track 17 or a retention rim 19.

The assumption of a “central” force effect serves merely for the sake of simplification in theoretical calculations.

As also shown by examinations and wear diagrams of the grinding parts, the radial forces acting on the tapered rollers 35 of the outer row are also reduced even further with a displacement of the resulting force 50 outwards.

This can lead in certain applications to this outer row of tapered rollers 35 being almost completely relieved from loads and the individual tapered rollers 35 no longer rolling as rolling bodies but instead sliding on the running surfaces due to lack of friction in the bearing. This effect is roughly comparable with the effect of aquaplaning. In terms of bearing this effect can result in a lubricating effect of the running tracks until the point of destruction due to inadequate lubrication.

It is therefore the object of the invention to overcome the indicated disadvantages and problems and to create a grinding roller, of which the bearing arrangement is less prone to wear and in consideration of a cost-effective solution.

This object is achieved according to the invention by the features of claim 1.

An essential core idea of the invention can be seen in moving away from the requirement established thus far, namely of providing the locating bearing in the end-face, inner region of the grinding roller, as the presumably significant forces acting on the roller jacket can then be absorbed in the close proximity of the locating bearing, and instead to design the whole bearing arrangement of the grinding roller in a contrary manner.

Within this contrary bearing principle, the locating bearing, so to speak, is arranged axially outwardly offset in the region of the roller base body or the roller core. At the same time the floating bearing, which has thus far been designed very generously and is preferably configured as a cylindrical roller bearing, is placed in the end-face region of the roller shaft, i.e. at the shortest distance from the peripheral area of the roller jacket.

The configuration of the bearing arrangement of the grinding roller according to the invention also allows the floating bearing now provided in the end-face region to have smaller dimensions than the floating bearing provided outwardly offset in the known bearing arrangement, so that according to the invention a cost saving is also achieved at the same time as qualitative improvement of the bearing arrangement of the grinding roller.

The roller base body or roller core is correspondingly supported according to the invention in its outer region with respect to the roller shaft advantageously by a double-row tapered roller bearing. This double-row tapered roller bearing acting as a locating bearing thus absorbs the radial and axial forces acting on the grinding roller.

The term “outer region” is to be understood within the scope of this application to be the region on the inclined shaft of the grinding roller pointing outwards in the direction of the rocker arm. In contrast, the “inwardly” orientated region means an orientation towards the centre of the grinding table or the centre of a corresponding vertical mill, in which the grinding roller is used.

Due to the inclination of the shaft of the grinding roller towards the grinding table and due to the extensively horizontal orientation of the grinding track of the grinding table, the peripheral contour of the roller jacket is designed as a frusto-conical-type peripheral contour. Due to this structure, a grinding gap is achieved between the grinding track and grinding roller with approximately equal distance over the radial extension.

Depending upon the raw material to be comminuted, the locating bearing is preferably designed when cement raw material is used as a double-row tapered roller bearing, while for the comminution of raw coal in vertical mills a double-row pendulum roller bearing is preferably used.

The double-row pendulum roller bearing has the advantage that it withstands both axial as well as radial loads in the corresponding dimensional scope and is well-suited to compensate alignment errors.

The double-row tapered roller bearing can comparably withstand very high loads both in the radial and axial direction. The double-row tapered roller bearing is preferably mounted in “X”-arrangement as a bearing. Depending upon the application, however, an “O”-arrangement is also possible.

The cylindrical roller bearing provided approximately at the end face between the roller shaft and roller core as a floating bearing can have relatively small dimensions due to the arrangement according to the invention of the locating bearing towards the outer region, whereby already a considerable cost saving can already be achieved.

In the arrangement according to the invention of the locating bearing and floating bearing therefore a modified load distribution between the two bearings and an increased load on the locating bearing are achieved due to the inclination of the shaft of the grinding roller and of the engagement point and the force direction of the resulting grinding force. This is especially advantageous when the resulting grinding force on the roller jacket engages further outwards, i.e. closer to the retention rim of the grinding table.

In this way a relieving of the load of one of the two roller bearings of the double-row tapered roller bearing is avoided, so that the previously mentioned problems and damage to the bearing can be prevented.

As the force to be transferred is lower on the floating bearing, this bearing configured in particular as a cylindrical roller bearing can be designed to be smaller and more cost-effective.

The subject matter of the application will be explained in more detail below by reference to schematic illustrations.

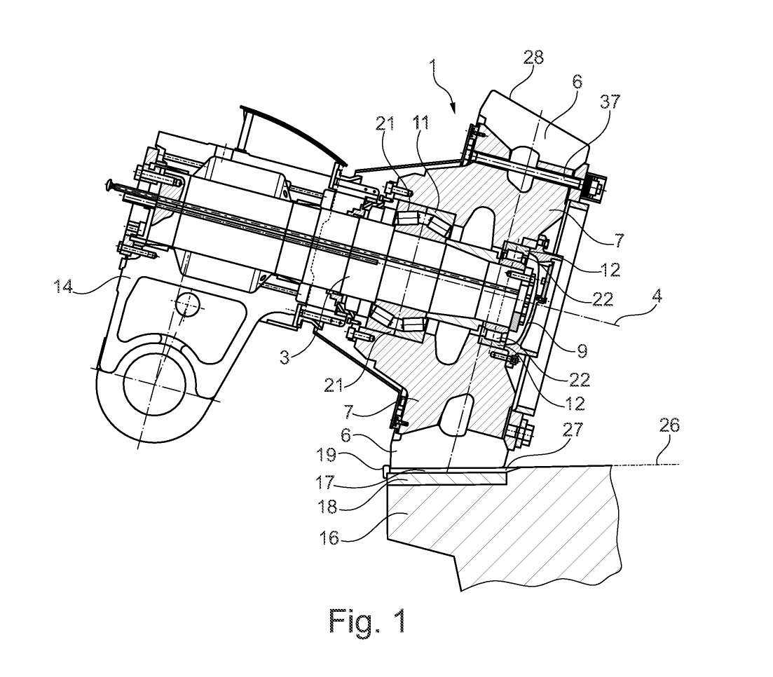

FIG. 1 shows an axial section through a grinding roller according to the invention with a corresponding bearing arrangement in relation to a grinding table shown in a fragmented manner in the lower region; and

FIG. 2 shows a comparable axial section through a conventional grinding roller with corresponding bearing arrangement, including an edge region of a grinding table.

FIG. 1 shows a grinding roller 1 according to the invention in an axial section with roller shaft 3 and the steering via a rocker arm 14. Having regard to the grinding and comminution function for raw material, a part of a grinding table 16 with grinding track plates 18, a retention rim 19 and a corresponding grinding gap 27 between the peripheral area of the roller jacket 6 and the surface of the grinding track plates 18 is shown in a fragmented manner in the lower region.

The peripheral area of the roller jacket 6 and the inclination 28 thereof with respect to the shaft 4 of the grinding roller is designed so that the grinding gap 27 extends approximately parallel to the grinding table plane 26.

It should be mentioned that the same reference numerals are used in FIG. 1 as in FIG. 2 for the same or the same type of assemblies of a corresponding grinding roller.

The roller shaft 3 is rigidly and rotationally securely fixed in the outer region (FIG. 1, left) in a corresponding recess of the rocker arm 14.

In the inwardly pointing region, which points approximately to the centre of the grinding table 16, the roller base body 7 or roller core with radially outwardly applied roller jacket 6 is mounted rotationally on the roller shaft 3 by means of a locating bearing 11 and a floating bearing 12.

The locating bearing 11 is designed in the example of FIG. 1 as a double-row tapered roller bearing 21 and set in an “O”-arrangement on the roller shaft 3. This locating bearing 11 is placed in the example in the outer region of the roller base body 7 orientated outwardly to the rocker arm 14, so that it can absorb the majority of the forces acting during operation on the lower region of the grinding roller jacket 6.

The floating bearing 12 provided in the end-face region 9 of the roller base body 7 and the grinding roller 1 on the roller shaft 3 therefore absorbs only relatively limited acting forces in the bearing arrangement according to the invention. For this reason, this floating bearing 12 can also have smaller dimensions than floating bearings 32 used thus far according to the prior art.

In the example according to FIG. 1, the bearing 12 is designed as a cylindrical roller bearing 22 and smaller than a conventional bearing 32 in the prior art.

The bearing arrangement of the grinding roller 1 according to the invention exhibits its outstanding advantages and the overcoming of the problems known in the prior art especially when the resulting force effect 50 in the grinding gap 27 shifts from the central, theoretical assumption radially outwards (left) in the direction of the indicated retention rim 19. It is particularly then that the locating bearing 11 according to FIG. 1 exhibits its outstanding effect, as the majority of the forces acting both radially and axially can be absorbed by this locating bearing.

The invention thus creates a bearing arrangement in a grinding roller 1 according to the invention, wherein the locating bearing 11 is arranged and designed to absorb the substantial forces, whereas the floating bearing 12 with smaller dimensions only has to absorb comparatively smaller forces. This solution also brings with it a lower degree of wear of the corresponding bearings, so that longer maintenance intervals can be applied.

1. Grinding roller,
with inclined, stationary inner roller shaft,
with roller jacket provided on a roller base body,
with a double-row roller bearing and a cylindrical roller bearing spaced apart therefrom arranged for bearing of the rotatable roller base body relative to the stationary inner roller shaft,
characterised in that
the cylindrical roller bearing is provided in the end-face region of the roller shaft for bearing the roller base body with roller jacket rotationally with respect to the stationary roller shaft, and
the double-row roller bearing is arranged outwardly offset on the roller shaft.

2. Grinding roller according to claim 1,
characterised in that
the roller jacket applied on the roller base body has a frusto-conical-type peripheral contour.

3. Grinding roller according to claim 1,
characterised in that
the double-row roller bearing is designed as a tapered roller bearing or as a pendulum roller bearing.

4. Grinding roller according to claim 1,
characterised in that
the double-row tapered roller bearing is designed as a reciprocally inclined roller bearing.

5. Grinding roller according to claim 1,
characterised in that
the end-face cylindrical roller bearing, with the same roller dimensions, can be designed to be smaller in terms of dimensions than an outer cylindrical roller bearing used to date.

6. Grinding roller according to claim 1,
characterised in that
the double-row tapered roller bearing is provided in “X”-arrangement or in “O”-arrangement.
